(19) United States
(12) Patent Application Publication
(10) Pub. No.: US 2023/0280811 A1
(43) Pub. Date: Sep. 7, 2023

(54) HIGH DENSITY POWER CONVERTER ARCHITECTURE FOR LOCALIZED REGULATION OF POWER PLANE

(71) Applicant: Empower Semiconductor, Inc., San Jose, CA (US)

(72) Inventors: Trey Roessig, Palo Alto, CA (US); Timothy Alan Phillips, Hope, RI (US); David Lidsky, Oakland, CA (US); Gerhard Schrom, Gales Creek, OR (US); Yali Xiong, San Jose, CA (US); Artin Der Minassians, Oakland, CA (US)

(73) Assignee: Empower Semiconductor, Inc., San Jose, CA (US)

(21) Appl. No.: 18/177,683

(22) Filed: Mar. 2, 2023

Related U.S. Application Data
(60) Provisional application No. 63/315,932, filed on Mar. 2, 2022.

(51) Int. Cl. G06F 1/28; H02M 1/00

(52) U.S. Cl. CPC G06F 1/28; H02M 1/0022

(57) ABSTRACT

An electronic system includes a circuit board including a power plane. An integrated circuit (e.g., processor) is attached to a first side of the circuit board and is arranged to receive power from the power plane. A plurality of DC-to-DC converters are attached to a second side of the circuit board and are arranged to transfer power to the power plane. Each DC-to-DC converter includes a respective voltage sense input that is electrically connected to a separate location on the power plane. A telemetry circuit is coupled to each of the plurality of DC-to-DC converters and is configured to detect a quantity of power transferred to the common power plane from each of the plurality of power conversion devices.

### CROSS-REFERENCES TO OTHER APPLICATIONS

This application claims priority to U.S. provisional patent application Ser. No. 63/315,932, for “HIGH DENSITY POWER CONVERTER ARCHITECTURE FOR LOCALIZED REGULATION OF POWER PLANE” filed on Mar. 2, 2022, which is hereby incorporated by reference in entirety for all purposes.

### BACKGROUND

Electronic systems continue to increase in complexity. Computing components, such as central processing units (CPUs), graphics processing units (GPUs), and general-purpose graphics processing units (GPGPUs), have generally followed Moore's Law, where the number of transistors within a CPU approximately doubles every two years. The ever-increasing number of transistors demand a corresponding ever-increasing amount of current from the associated power delivery system that must also support high current and voltage transients to control power dissipation within the device.

Typically, these components draw power from a power plane positioned within a circuit board or other substrate. The power delivery system is typically located adjacent around the periphery of the power plane to minimize the distance between the power delivery system and the point of load. As the current and/or voltage demands from the component change, the power delivery system responds. However, as current levels and transient requirements increase, the lateral power path from the power delivery system, laterally through the power plane to the component can introduce relatively large parasitic resistance, capacitance and inductance into the power delivery path. As a result, relatively large transients demanded by the device can cause corresponding relatively large voltage drops within the power plane. Unstable voltages on the power plane can result in the device entering an under-voltage shut down, generating errors and/or damage to the device.

New power supply architectures are needed to meet the demands of devices that require high currents and/or high transient power delivery.

### SUMMARY

In some embodiments an electronic system comprises a circuit board including a power plane. An electronic device is attached to a first side of the circuit board and is arranged to receive power from the power plane. A plurality of DC-to-DC converters are attached to a second side of the circuit board and are arranged to transfer power to the power plane, wherein each DC-to-DC converter of the plurality of DC-to-DC converters includes a respective voltage sense input that is electrically connected to a separate location on the power plane.

In some embodiments each DC-to-DC converter of the plurality of DC-to-DC converters is positioned within a length and a width of the power plane. In various embodiments the respective voltage sense input of each respective DC-to-DC converter is adjacent a position of each respective DC-to-DC converter on the power plane. In some embodiments the electronic system further comprises a supervisor control circuit arranged to detect a voltage of the power plane and to transmit a related control signal to each of the plurality of DC-to-DC converters.

In some embodiments the detected voltage is an average voltage of the power plane. In various embodiments the detected voltage is an average of the voltage sense inputs of each respective DC-to-DC converter. In some embodiments each of the plurality of DC-to-DC converters includes a localized control circuit that transfers power to the power plane in response the respective voltage sense input of each DC-to-DC converter. In various embodiments each of the plurality of DC-to-DC converters receives an input from a supervisor control circuit and transfers power to the power plane in response to the input. In some embodiments the electronic system further comprises a telemetry circuit coupled to each of the plurality of DC-to-DC converters and arranged to determine a quantity of power transferred to the power plane from each of the plurality of DC-to-DC converters.

In some embodiments an electronic system comprises a circuit board including a power plane. An electronic device is attached to a first side of the circuit board and is arranged to receive power from the power plane. A first DC-to-DC converter is attached to a second side of the circuit board and is arranged to transfer power to the power plane, wherein the first DC-to-DC converter is positioned at a first location within a length and a width of the power plane, and wherein the first DC-to-DC converter includes a first voltage sense input that senses a voltage of the power plane at the first location. A second DC-to-DC converter is attached to the second side of the circuit board and is arranged to transfer power to the power plane. The second DC-to-DC converter is positioned at a second location within the length and the width of the power plane and the second DC-to-DC converter includes a second voltage sense input that senses a voltage of the power plane at the second location.

In some embodiments the first DC-to-DC converter is arranged to transfer power to the power plane at the first location and the second DC-to-DC converter is arranged to transfer power to the power plane at the second location. In various embodiments the electronic system further comprises a supervisor control circuit arranged to detect a voltage of the power plane and to transmit a related control signal to each of the first and the second DC-to-DC converters. In some embodiments the detected voltage is an average voltage of the power plane. In various embodiments the detected voltage is an average of the first and the second voltage sense inputs.

In some embodiments the first DC-to-DC converter includes a first localized control circuit that transfers power to the power plane in response to the first voltage sense input, and the second DC-to-DC converter includes a second localized control circuit that transfers power to the power plane in response to the second voltage sense input. In various embodiments the first DC-to-DC converter receives an input signal from a supervisor control circuit and transfers power to the power plane in response to the input signal and wherein the second DC-to-DC converter receives the input signal from the supervisor control circuit and transfers power to the power plane in response to the input signal.

In some embodiments the electronic system further comprises a telemetry circuit coupled to the first DC-to-DC converter and arranged to determine a quantity of power transferred to the power plane from the first DC-to-DC converter, the telemetry circuit coupled to the second DC-to-DC converter and arranged to determine a quantity of power transferred to the power plane from the second DC-to-DC converter.

In some embodiments an electronic system comprises a plurality of power conversion devices arranged to be coupled to a common power plane wherein each power conversion device senses a respective voltage at a different physical location on the common power plane. A telemetry circuit is arranged to be coupled to each of the plurality of power conversion devices and configured to detect a quantity of power transferred to the common power plane from each of the plurality of power conversion devices. In various embodiments each of the plurality of power conversion devices are DC-to-DC converters. In some embodiments the electronic system further comprises a control circuit that is arranged to receive data from the telemetry circuit and in response to receiving the data, transmit control signals to each of the plurality of power conversion devices.

These and other embodiments of the invention along with many of its advantages and features are described in more detail in conjunction with the text below and attached figures.

### BRIEF DESCRIPTION OF THE DRAWINGS

FIG. 1 illustrates an isometric top view of a portion of a simplified electronic system, according to an embodiment of the disclosure;

FIG. 2 illustrates an isometric bottom view of the simplified electronic system illustrated in FIG. 1;

FIG. 3A illustrates an isometric bottom view of a portion of a simplified electronic system, according to an embodiment of the disclosure;

FIG. 3B illustrates an isometric top view of a portion of a simplified electronic system, according to an embodiment of the disclosure;

FIG. 4 illustrates a bottom plan view of the electronic system illustrated in FIGS. 1 and 2;

FIG. 5 illustrates a simplified cross-sectional schematic of the power flow in the electronic system illustrated in FIGS. 1, 2 and 4; and

FIG. 6 illustrates a simplified electrical schematic of one embodiment of a control scheme for the simplified electronic system illustrated in FIG. 1.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques disclosed herein relate generally to power converters. More specifically, techniques disclosed herein relate to DC-to-DC power converters that provide power to one or more integrated circuit (IC) devices. Various inventive embodiments are described herein, including methods, processes, systems, devices, and the like.

In order to better appreciate the features and aspects of the present disclosure, further context for the disclosure is provided in the following section by discussing one particular implementation of a DC-to-DC power converter architecture that includes a plurality of high-density miniaturized multiphase autonomous converters (also called leaves, herein) that are coordinated by a primary control unit (also called a supervisor, herein). The plurality of leaves can be physically distributed across a region of a circuit board that contains a power plane arranged to supply power to an IC device positioned on an opposite side of the circuit board from the plurality of leaves. Each leaf has a miniaturized physical outline and can include semi-autonomous control circuitry that senses and controls the voltage at a localized region of the power plane. More specifically, as the IC device draws non-uniform current from the power plane, voltage variations are induced in the power plane which are corrected by one or more leaves positioned at those specific locations. Thus, the leaves are small enough to enable a plurality of leaves to be distributed across a continuous power plane and the leaves are fast enough to mitigate voltage variations induced in the power plane.

The supervisor coordinates the operation of the plurality of leaves, for example during power up of the IC device, power down of the IC device or changing a voltage of the power plane during mode changes of the IC device. In some instances, embodiments of the disclosure are particularly well suited for use with IC devices that include a plurality of high current processor cores where each core independently has high transient current demands. The small form-factor of the leaf-based power converter architecture and its ability to rapidly regulate the voltage across a continuous power plane extending under the IC device can minimize input voltage variations for the IC device.

The embodiments described herein are for explanatory purposes only and other embodiments may be employed in other electronic systems. For example, embodiments of the disclosure can be used with any power converter system including DC-to-AC, AC-to-AC and AC-to-DC converters and can be used to supply power to other types of devices or systems.

### Power Supply Architecture

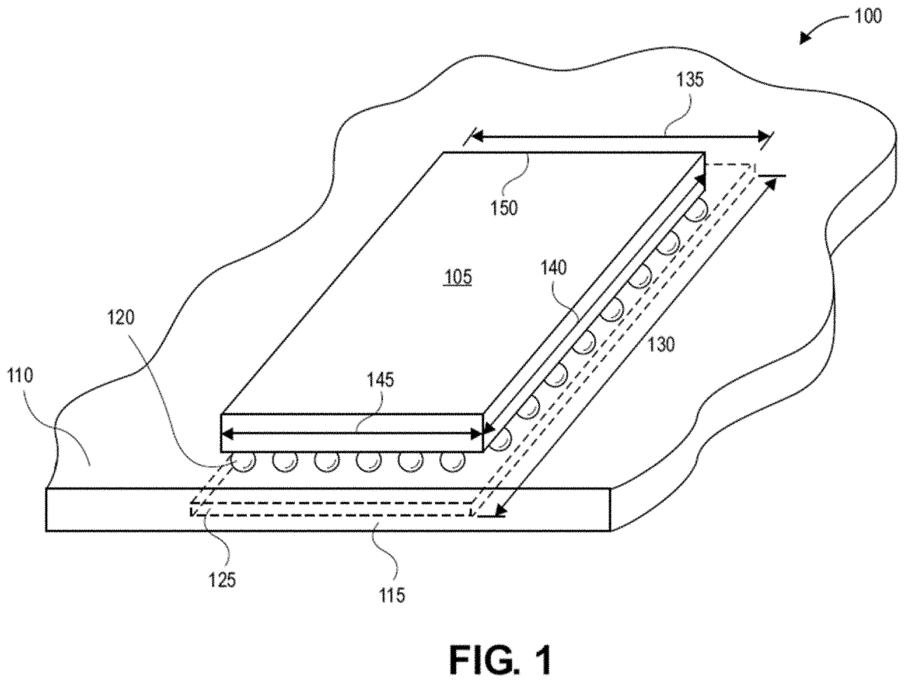

FIG. 1 illustrates an isometric top view of a portion of a simplified electronic system 100, according to an embodiment of the disclosure. This figure, as with the other figures, is included for illustrative purposes and does not limit either the embodiments of the present invention or the claims. As shown in FIG. 1, electronic system 100 can include an IC device 105, that can be attached to a top surface 110 of a circuit board 115. IC device 105 can include a plurality of terminals 120 that can be used for power and/or signal connections to circuit board 115. In this particular embodiment plurality of terminals 120 are shown as solder balls, however other embodiments can use leads, pins, land-grid arrays or any other suitable interconnect structure.

A portion of plurality of terminals 120 can electrically couple IC device 105 to a power plane 125 that is embedded within circuit board 115. In some embodiments power plane 125 can include a layer of metal that is positioned at any location (e.g., top layer, middle layer(s), bottom layer) within circuit board 115. In various embodiments a length 130 and a width 135 of power plane 125 can be substantially equal to a corresponding length 140 and width 145 of a perimeter 150 of IC device 105. In some embodiments length 130 and width 135 of power plane 125 can be greater than or less than length 140 and width 145 of IC device 105. In various embodiments IC device 105 can be a GPU, CPU, GPGPU or any other type of electronic device. In one embodiment IC device 105 includes a plurality of microprocessors that can be operated independently with power supplied from power plane 125. As appreciated by one of skill in the art having the benefit of this disclosure, circuit board 115 can be any suitable size, can be made from any suitable material and can include any number of electronic components, in addition to IC device 105.

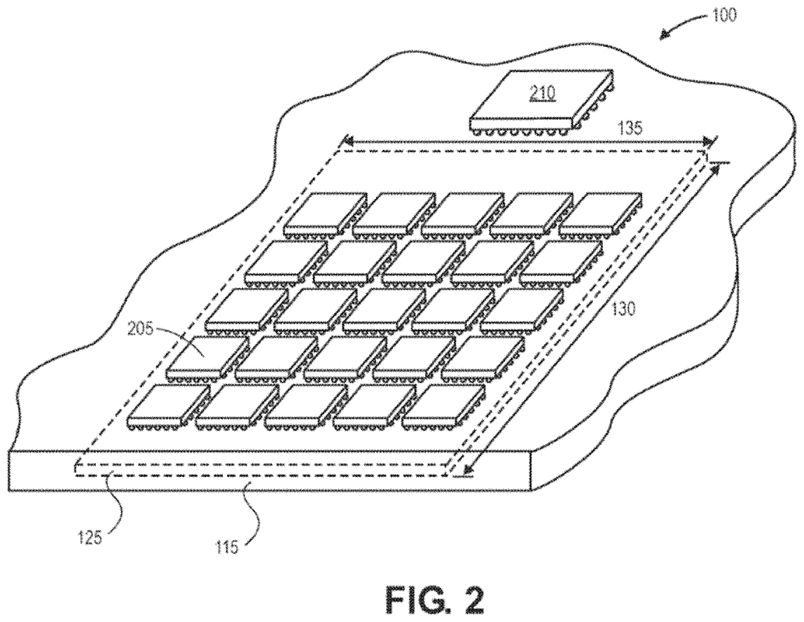

FIG. 2 illustrates an isometric bottom view of simplified electronic system 100, illustrated in FIG. 1. As shown in FIG. 2, a two-dimensional array of DC-to-DC converter leaves 205 are attached to a bottom surface of circuit board 115 and are distributed across power plane 125. Each DC-to-DC converter leaf 205 includes semi-autonomous control circuitry that senses and controls the voltage of a localized region of power plane 125. In some embodiments plurality of leaves 205 can be positioned within length 130 and width 135 of power plane 125, within length 140 (see FIG. 1) and width 145 of IC device 105 and/or within perimeter 150 of IC device 105. A primary control unit 210 (also called a supervisor) can coordinate the global control of plurality of leaves 205. In other embodiments the functions of supervisor 210 may be integrated within one or more leaves 205.

In some embodiments each leaf 205 includes a local sense input that senses a voltage of power plane 125 at a location in the vicinity of (e.g., proximate, or adjacent to) the respective leaf. Each leaf 205 can include semi-autonomous control circuitry that enables each leaf to respond to and correct voltage variations induced in power plane 125 by IC device 105 (see FIG. 1). Therefore, as regions of IC device 105 (see FIG. 1) demand high transient power delivery (e.g., current) from power plane 125, voltage variations can be induced in the power plane which are compensated by the one or more leaves 205 in those regions. In some embodiments power plane 125 can be a single metal layer within circuit board 115, however in other embodiments the power plane can include two or more layers within the circuit board (these planes are collectively referred to herein as power plane 125.) In various embodiments, power plane 125 can be arranged as a grid including multiple interconnected conductors that have one or more spaces or gaps. In some embodiments, power plane 125 is a single electrical conductor that is arranged to conduct current from one or more leaves 205 to IC device 105.

### Control Architectures

Supervisor 210 can control each of the plurality of leaves 205 by transmitting commands via one or more series or parallel command buses (not shown) to each of the plurality of leaves. In some embodiment supervisor 210 can be used to power up one or more leaves 205, power down one or more leaves, change a voltage set point of one or more leaves, optimize an operating efficiency of the plurality of leaves or perform other suitable functions. In one embodiment, once IC device 105 (see FIG. 1) is powered up and operating normally, supervisor 210 can transmit a reference voltage setting to each leaf 205, wherein each leaf uses that setting for localized semi-autonomous control. In another embodiment supervisor 210 can transmit a new reference voltage setting to each leaf 205 when IC device 105 enters a low-power sleep state. In further embodiments, supervisor 210 can turn a number of plurality of leaves 205 off during steady-state operation of IC device 105 to maximize power conversion efficiency of the leaves that remain operating. In some embodiments supervisor 210 can turn off one or more leaves 205 that are furthest from the high power draw regions of the power plane. In various embodiments supervisor 210 can increase current output from one or more leaves that are closest to a region of high power draw from the power plane to minimize resistive losses within the power plane. In some embodiments, leaves can be configured to supply unequal maximum currents. In various embodiments, the size of the power semiconductor devices are not the same on each leaf. One of skill in the art having the benefit of this disclosure will appreciate the many different commands that can be sent by supervisor 210.

As compared to traditional designs that may include a physically larger power converter device positioned at a periphery of power plane 125, the two-dimensional array of miniaturized DC-to-DC converter leaves 205 enables faster response times to voltage variations within the power plane due to lower parasitic inductance, capacitance and resistance between the power converter and the point of load. The leaf architecture also enables control over individual regions of a contiguous power plane as opposed to traditional designs that only provide global control over the power plane voltage that is typically sensed at one location. Further, the leaf architecture enables improved efficiency as the I²R losses are reduced in proportion to the reduced distance between the power converter and the point of load. More specifically, the leaf architecture can result in a substantially vertical flow of power from the DC-to-DC converter vertically through the power plane to the point of load, as compared to a traditional design where the flow of power is predominantly lateral, from the power converter, laterally along a length of the power plane, then to the point of load.

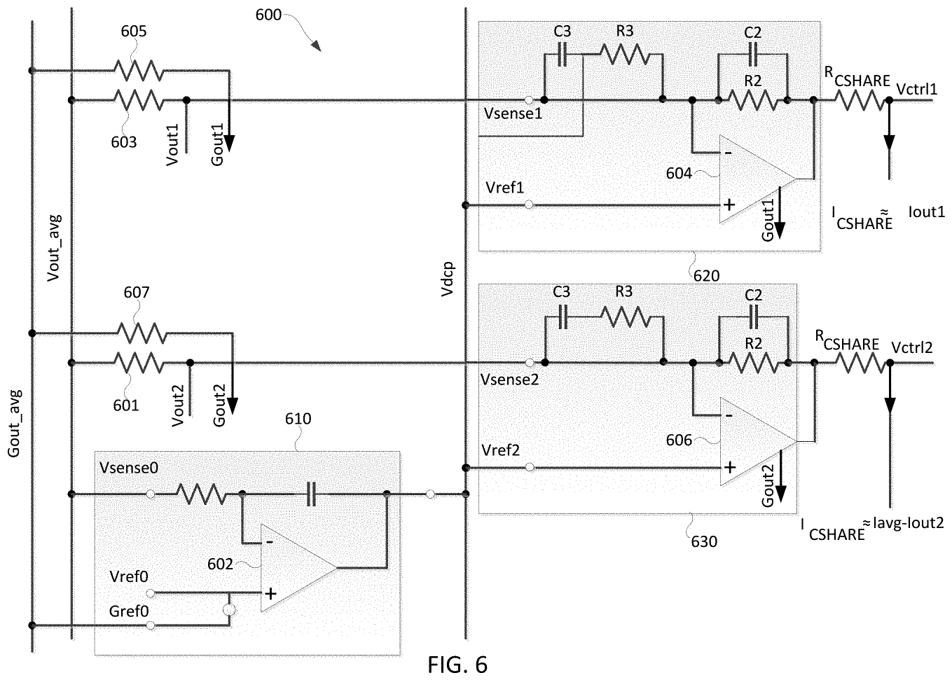

As described above, each leaf 205 can sense a voltage at its corresponding sense location on the power plane 125 and compare the sensed voltage to a desired voltage (e.g., reference voltage set by supervisor 210). In response to the sensed voltage being less than the desired voltage, the leaf 205 can transfer more power from its input to provide an increase in output power that compensates for the local voltage drop in the region of the power plane, forcing the voltage at that location in the power plane back to the desired voltage. Each leaf 205 can sense a voltage near its location on the power plane 125, near a terminal of IC device 105, within the IC device or at another suitable location. In some embodiments supervisor 210 can use an average of two or more voltages sensed on different points (e.g., sense points) of the output plane as an input for control of the leaves. In some embodiments one or more of the sense points can also be used as sense points on one or more leaves. In some embodiments an average of two or more sense points of a ground can be used as an input to the supervisor 220. In various embodiments the averaging may be performed by one or more resistors (e.g., shown in FIG. 6). Similarly, in some embodiments each leaf 205 can sense a ground near its location and supervisor 210 can use an average of two or more of the sensed ground signals as an input (shown in FIG. 6). In various embodiments supervisor 210 and/or each leaf 205 can employ one or more phase-locked loop (PLL) circuits (not shown).

In some embodiments each leaf 205 includes a high-density monolithic multiphase power converter die (not shown in FIG. 2). Each leaf 205 can be a one-phase, two-phase, three-phase, four-phase, or more than four-phase DC-to-DC converter circuit. In some embodiments the timing of the phases can be synchronized among the multiple leaves. In other embodiments the timing of one or more of the phases can be out of phase, that is, one or more of the phases may not be synchronized. In other embodiments, one or more leaves may operate at one or more independent (e.g., a different switching frequency than one or more other leaves) switching frequencies. That is, one or more of the leaves can use a switching frequency that is different than one or more of the other leaves. In various embodiments the timing of the phases can be varied in a spread-spectrum manner to reduce EMI-based noise. The power converter circuits can be low-drop out regulators, buck converters, boost converters, buck-boost converter, or other suitable type of DC-to-DC converter. One of skill in the art having the benefit of this disclosure will appreciate that other power converter architectures can be used and are within the scope of this disclosure, such as, for example a resonant rectified discontinuous switching regulator as described in more detail in co-owned U.S. Pat. No. 9,300,210, which is incorporated by reference herein in its entirety. In some embodiments one or more discrete passive components are integrated within each leaf 205, such as one or more input capacitors, one or more output capacitors and/or one or more output inductors. In some embodiments the leaves 205 are configured to operate at relatively high switching frequencies (e.g., 10 MHz or greater) to minimize a size of the discrete passive components, to minimize response time and/or enable circuit board or other features to function as passive devices (e.g., output inductor, capacitors, etc.).

In further embodiments each leaf 205 may include a plurality of semiconductor devices including discrete or integrated power switches, diodes and/or one or more control circuits. In other embodiments each leaf 205 may include multiple separate packaged electronic devices that are individually attached to circuit board 115. In yet further embodiments each leaf 205 includes a one, two, three or more phase DC-to-DC converter circuit and may be a part of a flexible fabric of power converters where two or more leaves can operate in conjunction with each other in a spread spectrum or other switching architecture, then be flexibly reconfigured to operate with other leaves within the fabric to balance power, reduce EMI noise or to improve thermal management. One of skill in the art having the benefit of this disclosure will appreciate the varied control architectures that can be used which are within the scope of this disclosure, such as, for example co-owned and co-pending U.S. patent application Ser. No. 17/175,466, which is incorporated by reference herein in its entirety.

In some embodiments, leaves 205 can be arranged in a two-dimensional array (e.g., shown in FIG. 2 as a five-by-five array). Leaves 205 can also be arranged in other configurations, such as for example, a four-by-five array, a five-by-six array, a six-by-six array, or other suitably sized array. In some embodiments leaves 205 can be placed in a regularly spaced pattern as shown in FIG. 2, while in other embodiments they can be placed in a radial, circular or non-uniform pattern where a plurality of leaves are clustered around high power draw regions of IC device 105. In some embodiments plurality of leaves 205 can supply IC device 105 with over 1000 amps of current while maintaining power plane 125 at a relatively uniform voltage of less than 1 volt. In some embodiments length 140 and width 145 of IC device 105 can be less than 100 mm, less than 75 mm, less than 50 mm, less than 25 mm or less than 20 mm.

### Supervisor and Control Functions

In some embodiments, supervisor 210 can provide a relatively slow, global control of the array of leaves 205, for example by setting the magnitude of the voltage to be provided (e.g., reference voltage), changing the magnitude of the voltage to be provided based on a change in state of the electronic device (e.g., entering a sleep mode), setting current limits, and performing other functions. In some embodiments some or all of the functionality of supervisor 210 can be integrated within one or more leaves 205. In various embodiments supervisor 210 can operate at a slower speed than leaves 205 while in other embodiments the supervisor can operate at 10 MHz or faster clock speeds.

In some embodiments supervisor 210 can communicate to each leaf via a series, parallel and/or daisy chained communication bus. Supervisor 210 can use any of or a combination of analog communications, digital communications, optical communications and wireless communications to exchange information with each leaf 205, IC device 105, and/or other electronic system. In some embodiments there is no supervisor and each leaf 205 is fully autonomous. In one embodiment supervisor 210 is a microcontroller that controls leaves 205 via digital communications. In other embodiments supervisor 210 has a single reference voltage bus that all leaves 205 follow and where each of the leaves are otherwise autonomous. In some embodiments each leaf 205 can communicate with each other leaf via series or parallel communications channels that employ optical, digital and/or analog protocols.

In further embodiments supervisor 210 or leaves 205 communicate with IC device 105 and/or another electronic system that transmits a preemptive command for one or more of the leaves 205 to deliver increased power to meet an imminent high power demand from the IC device. More specifically, in some embodiments IC device 105 may know that a particularly high current draw is imminent for one or more processors and may communicate that information to supervisor 210 which commands leaves 205 in the high current draw regions to start transferring increased power to mitigate a change in the voltage of the power plane.

For example, when IC device 105 powers up it may always power specific leaves 205. In some embodiments supervisor 210 may use a look up table such that when IC device initiates a startup sequence it uses the lookup table to preemptively transfer power and/or change a voltage of the power plane to mitigate variations induced in the power plane. Similarly, in some embodiments IC device 105 may know that a reduction in current draw is imminent for one or more processors and may communicate that information to supervisor 210 which commands leaves 205 in the reduced current draw regions to start reducing power to mitigate a change in the voltage of the power plane. Supervisor 210 can be implemented in various ways. For example, microcontrollers, field-programmable gate arrays, and other circuits can be employed to implement supervisor circuitry.

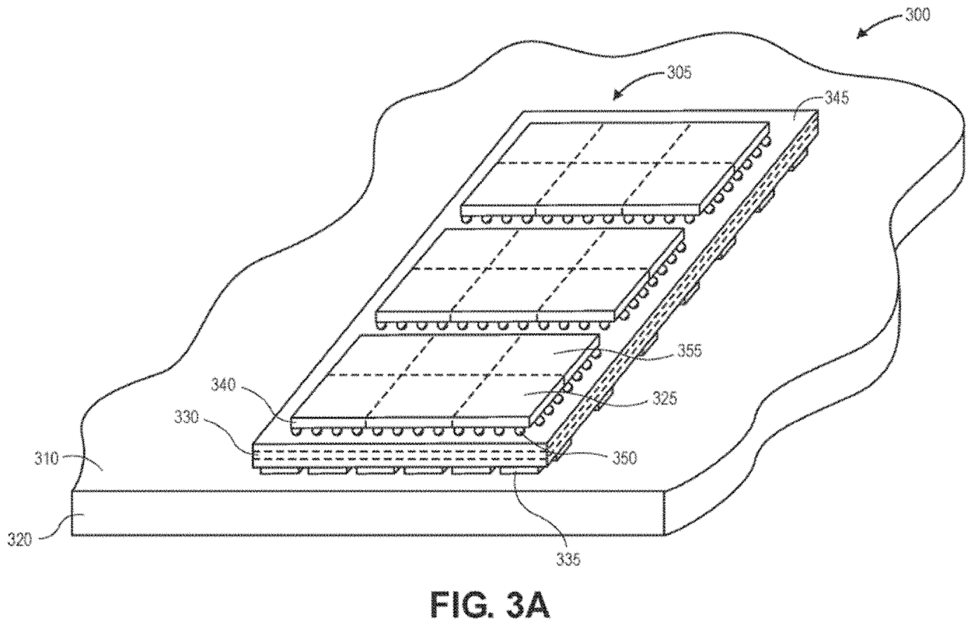

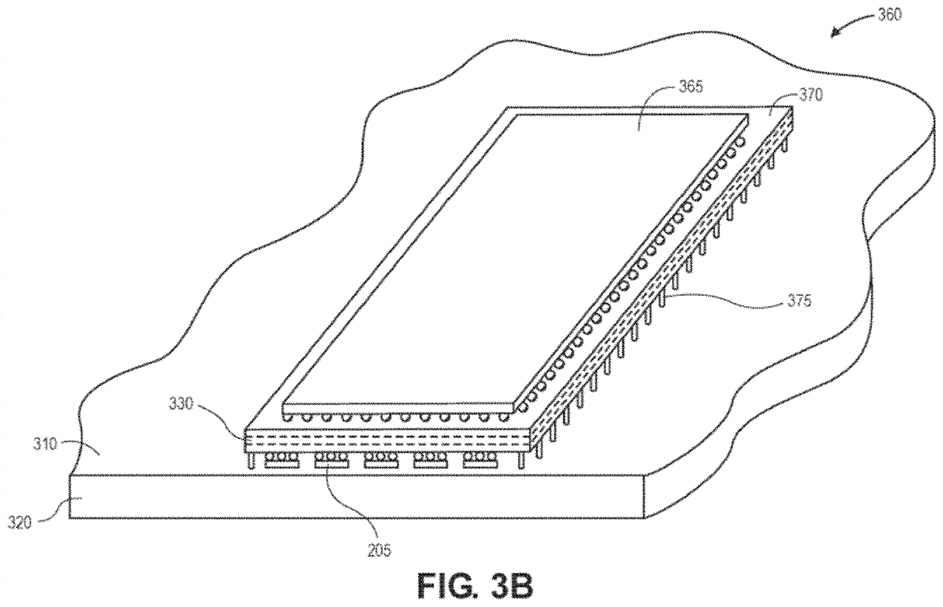

FIG. 3A illustrates an isometric bottom view of a portion of another embodiment of a power converter system 300, according to an embodiment of the disclosure. Electronic system 300 is similar to electronic system 100 described in FIGS. 1 and 2, however, electronic system 300 includes a unitary power supply package 305 attached to a bottom surface 310 of a circuit board 320, where the unitary power supply package includes a plurality of internal leaves 325 coupled to an internal power plane 330. As shown in FIG. 3A, unitary power supply package 305 is attached to circuit board 320 through a plurality of land-grid array connections 335 and is positioned opposite an IC device (not shown) attached to a top surface of the circuit board. Power supply package 305 includes one or more monolithic die 340 that each include a plurality of leaves 325. In FIG. 3A each monolithic die 340 includes 6 leaves such that power supply package 305 includes 18 leaves arranged in a 3×6 array, however other embodiments may have any suitable number of leaves in any suitable geometric arrangement. As described above, each leaf can include a semi-autonomous one, two, three, four or more phase DC-to-DC converter circuit. In further embodiments each leaf can be a separate die while in other embodiments all leaves can be integrated on one monolithic die instead of the three shown in FIG. 1. In other embodiments, each power switch within each leaf can be a discrete die.

Power supply package 305 includes a substrate 345 that includes internal power plane 330 which can function similar to power plane 125 described in FIGS. 1 and 2. More specifically, in this particular embodiment, each leaf 325 is electrically coupled to internal power plane 330 rather than to a power plane in circuit board 320. Therefore, each leaf 325 senses a voltage at a region of internal power plane 330 and transmits power to that region of the power plane in response to the sensed voltage thereby maintaining the internal power plane at a uniform and constant voltage. Internal power plane 330 can be electrically coupled to the IC die via land-grid array 335, obviating the need for a power plane within circuit board 320. However, in other embodiments circuit board 320 can also include a power plane that is electrically coupled to internal power plane 330. In some embodiments having multiple parallel power planes can further reduce voltage variations in the combination of power planes and can assist with uniform distribution of heat. In this particular example embodiment each die 340 is coupled to substrate 345 via a plurality of solder balls 350, however other suitable interconnects can be used such as columns, land-grid arrays, wirebonding and the like.

In further embodiments a heatsink (not shown) can be coupled to a top surface of power supply package 305 to transfer thermal energy from leaves 325 to the air, or to another medium. Power supply package 305 may also include an encapsulant or underfill (not shown for clarity) that encapsulates at least a portion of each die 340 for environmental and/or mechanical protection. In one embodiment, back surfaces 355 of die 340 are exposed at the top surface of power supply package 305 such that the heatsink can be directly coupled to the die for efficient thermal transfer. A similar construction can be used for the embodiment described in FIGS. 1 and 2 where the die(s) within each leaf can have a back surface exposed for direct coupling to a heatsink. In some embodiments the heatsink may be designed to have a high degree of lateral thermal conductivity to efficiently transfer thermal energy from the high power density leaves with minimal temperature drop. In further embodiments the high degree of lateral thermal conductivity may enable a leaf that is responding to a high transient load to spread its thermal energy across adjacent regions of the heatsink, especially when adjacent leaves are in a low power state and are dissipating a relatively low amount of thermal energy. More specifically, the heatsink may be configured to redistribute a high thermal density from a leaf that is under a high load across a large region of the heatsink to reduce the temperature drop between the power supply die and the heatsink.

In another embodiment a plurality of leaves can be distributed around the periphery of a power plane and can be positioned on the same side of the circuit board as the IC device, or on the opposite side. In some embodiments the power plane within the circuit board may extend beyond the perimeter of the IC device and extend under each of the leaves positioned outside of the perimeter of the IC device so each leaf can be directly coupled to the power plane. As appreciated by a person of skill in the art having the benefit of this disclosure other various geometries and permutations of leaves, power planes and arrangements thereof can be used and are within the scope of this disclosure.

FIG. 3B illustrates an isometric top view of a portion of another embodiment of a power converter system 360, according to an embodiment of the disclosure. Electronic system 360 is similar to electronic system 100 described in FIGS. 1 and 2, however, electronic system 360 includes an IC device 365 attached to a substrate 370 that can be an interposer or a portion of an electronic package for the IC device. IC device 365 can be attached to substrate 370 using flip-chip or other suitable technology and can have an exposed back surface arranged to be coupled to a heatsink. Substrate 370 can be attached to a bottom surface 310 of a circuit board 320 using columns 375 or other suitable attachment structures. A two-dimensional array of DC-to-DC converter leaves 205 are attached to a bottom surface of substrate 370 and are distributed across a power plane 380. As described above, each DC-to-DC converter leaf 205 includes autonomous or semiautonomous control circuitry that senses and controls the voltage of a localized region of power plane 380. In an alternative embodiment, one or more leaves 205 can be combined into a monolithic die, as described in greater detail with regard to FIG. 3A.

In some embodiments multiple leaf circuits 205 can be integrated on a single die and can interface with respective output inductors that employ a common core. In some embodiments the respective output inductors can be formed within a single electronic package having respective inputs and outputs for each respective inductor.

In some embodiments each leaf 205 can be integrated within a leaf package (not shown) where the leaf package also includes for example, an output inductor, output capacitance and/or input capacitance. In some embodiments the leaf package can be a quad-flat no-lead (QFN), a multichip module, a chip-scale package with interposer or any other type of suitable electronic package.

### Power Delivery Spatial Telemetry

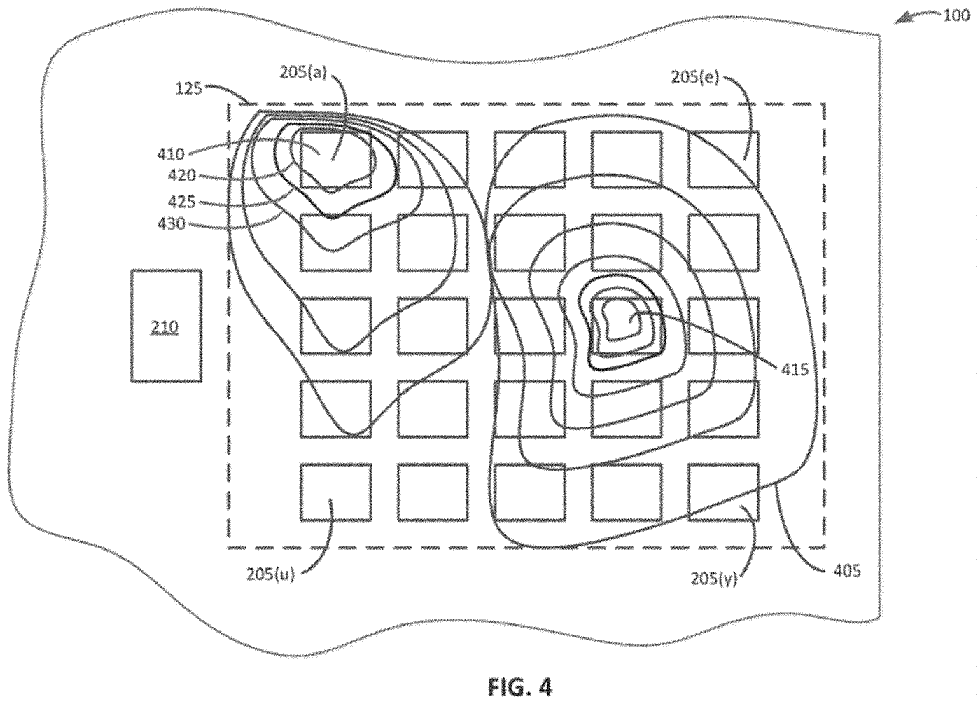

FIG. 4 illustrates a bottom plan view of electronic system 100, illustrated in FIGS. 1 and 2. In this embodiment each respective leaf 205(a) . . . 205(y) is configured to communicate data indicating the quantity of power it is transferring to power plane 125. In some embodiments each leaf 205 can communicate the power information to supervisor 210, while in other embodiments the power information can be communicated to a different electronic system. In some embodiments the power information can be used by IC device 105 (see FIG. 1) to redistribute processor workloads to processors that are physically distanced from the high power consumption processors or to reduce the thermal load and power draw densities of system 100. As appreciated by one of skill in the art having the benefit of this disclosure the power information from leaves 205 can be used for other purposes, such as for example, generating a power contour graph that represents the amount of power consumed by each region of IC device 105. Such information can be informative for IC device design, IC device management and other functions.

More specifically, in this particular example, power generation information from each leaf 205(a) . . . 205(y) can be combined with the physical location of each leaf to create an instantaneous power consumption contour graph 405 of power plane 125. In this particular example IC device 105 (see FIG. 1) includes six microprocessors where a power pin of the first processor is located over leaf 205(a) and a power pin of a fourth microprocessor is located over leaf 205(n). During a particular task, such as power up, the first and the fourth processors draw 100 percent of their rated power while the other processors draw significantly less power. To mitigate voltage variations that this power draw would induce in power plane 125, leaves 205(a) and 205(n) produce significantly more power than any of the other leaves creating the illustrated contour graph 405 with first peak 410 over leaf 205(a) and second peak 415 over leaf 205(n). In this particular embodiment, each line of the contour graph represents a uniform level of power input into power plane 125. For example, line 420 near peak 410 represents 20 Watts while line 425 represents 15 Watts, line 430 represents 10 Watts, etc. Thus, the physical location of each leaf can be combined with the power discharged from each leaf into the power plane to provide spatial telemetry of the power consumption of IC device 105 (see FIG. 1).

In some embodiments each leaf 205 can detect the power it's discharging into power plane 125 via one or more internal current sensors, such as, for example a sense resistor, a sense transistor in parallel with one or more power transistors, a voltage drop across an output inductor, switch on-time, or other current sensing method. The voltage at the power plane sense location of the leaf can be detected via a kelvin connection or other voltage sensing circuit. The resulting voltage and current information can be converted to power information by each leaf and/or each leaf can transmit the voltage and current information to supervisor 210 or another circuit.

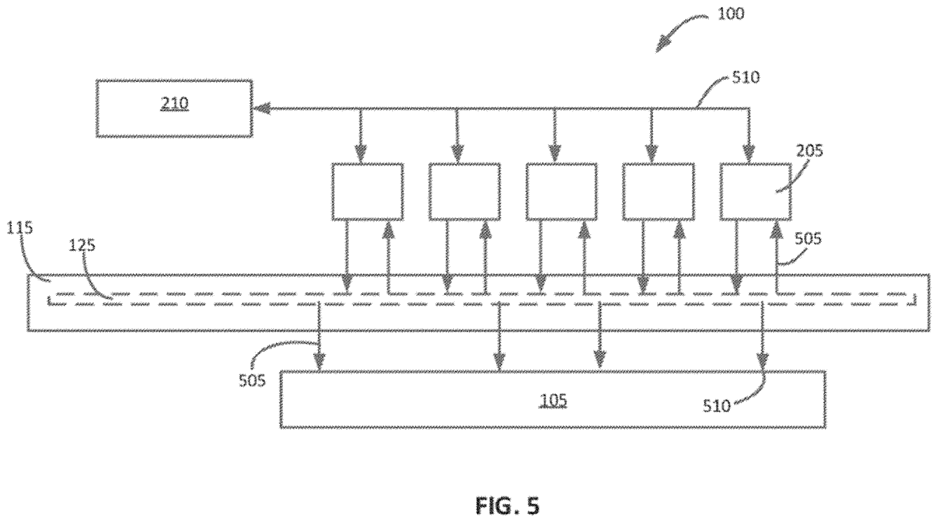

FIG. 5 illustrates a simplified cross-sectional schematic of the power flow in electronic system 100 illustrated in FIGS. 1, 2 and 4. As shown in FIG. 5, electronic system 100 can include IC device 105 attached to circuit board 115. An array of DC-to-DC converter leaves 205 can be attached to power plane 125 that is located within circuit board 115. Supervisor circuit 210 can also be attached to printed circuit board 115. This configuration can provide a current flow through power plane 125 that is predominantly vertical from DC-to-DC converter leaves 205, through vias 505 to power terminals 510 of IC device 105. In these and other embodiments of the present invention, printed circuit board 115 can be at least partially omitted and power plane 125 can be a layer in a substrate of a package (not shown), an interposer (not shown) or a layer of metal.

Each DC-to-DC converter leaf 205 can include a control loop (not shown) to regulate its output voltage. The control loop can include a pulse-width modulator (PWM) or other control circuit. A reference voltage can be generated by or associated with each leaf 205. Alternatively, a reference voltage can be generated by or associated with supervisor 210 and distributed using communication bus 510 to some or all leaves 205. The reference voltage can be provided by a bandgap circuit, Zener diode, PN-junction, or other reference circuit (not shown.)

In some embodiments leaves 205 can provide information over communication bus 510 to supervisor 210. This information can be the power supply voltage, the power supply current, the power supplied or other suitable data. This data can allow supervisor 210 to track power transferred into power plane 125 from each leaf 205.

### Example Control Scheme

FIG. 6 illustrates a simplified electrical schematic of one embodiment of a control scheme 600 for the simplified electronic system illustrated in FIG. 1. In some embodiments, a supervisor circuit 610 can use an average of two or more voltages sensed at different points (e.g., sense points) and/or the average of two or more ground signals to update reference voltages for at least one leaf in power plane 125. In some embodiments, the one or more sense points can also be used as sense points on one or more leaves. A first leaf at a first position on the power plane 125 can sense a first sensed voltage (Vout1) and a first sensed ground signal (Gout1) at the first position. A second leaf at a second position on the power plane 125 can sense a second sensed voltage (Vout2) and a second sensed ground signal (Gout2) at the second position.

As shown in FIG. 6, the first and second sensed voltages (denoted Vout1 and Vout2) and the first and second sensed ground signals (denoted Gout1 and Gout2) can be used by the supervisor circuit 610. Averaging of the first sensed voltage, Vout1, can be performed by a resistor 601 and averaging of the second sensed voltage can be performed by a resistor 603. The average of the two sensed voltages is denoted Vout_avg. Averaging of the first sensed ground signal, Gout1, can be performed by a resistor 605 and averaging of the second sensed ground signal, Gout2, can be performed by a resistor 607. The average of the two ground signals is denoted Gout_avg in FIG. 6.

The supervisor circuit 601 can include two input parameters, Vsense0 and Vref0, for a supervisor amplifier 602. Vsense0 can depend on Vout_avg, and Vref0 can depend on Gout_avg. Based on a comparison of the two input parameters, the supervisor circuit 601 can modulate reference voltages for a plurality of leafs in the power plane 125 via a modulation of a control signal Vdcp. FIG. 6 also depicts control circuitry 620 for the first leaf and control circuitry 630 for the second leaf. The first leaf can sense a voltage of a first localized region of the power plane 125. The sensed voltage of the first localized region is denoted Vsense1 in FIG. 6. In some embodiments, the first localized region includes the first position and the sensed voltage of the first localized region, Vsense1, is equivalent to the first sensed voltage, Vout1. The control circuitry 620 can compare Vsense1 to a reference voltage, Vref1. An amplifier 604 of the control circuitry 620 can adjust, based on the comparison, the voltage of the first localized region to a control value, Vctrl1. Vref1 can depend on the control signal, Vdcp, and can be updated by the supervisor circuit 610. Therefore, the first leaf can react to localized variations in a voltage of the power plane 125 to quickly counteract any localized voltage rises or drops and can also be used to manage the overall average voltage of the power plane via the control signal sent by supervisor 610.

The second leaf can sense a voltage of a second localized region of the power plane 125. The sensed voltage of the second localized region is denoted Vsense2 in FIG. 6. In some embodiments, the second localized region includes the second position and the sensed voltage of the second localized region, Vsense2, is equivalent to the second sensed voltage, Vout2. The control circuitry 630 for the second leaf can compare Vsense2 to a second reference voltage, Vref2. An amplifier 606 of the control circuitry 630 can adjust, based on the comparison, the voltage of the second localized region to a control value, Vctrl2. Vref2 can depend on the control signal, Vdcp, and can be updated by the supervisor circuit 610. Therefore, the second leaf can react to localized variations in voltage of the power plane 125 to quickly counteract any localized voltage rises or drops and can also be used to manage the overall average voltage of the power plane via the control signal sent by supervisor 610.

In some embodiments supervisor 610 can send “averaged” control signals to each leaf to manage the average voltage of the power plane and each leaf can independently react to counteract any localized variations in the power plane that deviate from the “averaged” control signals sent by the supervisor. In various embodiments Gout_avg becomes a reference net for Bdcp, PWM triangle, PWM sawtooth and other types of waveforms.

For simplicity, various internal components, such as the control circuitry, communications circuitry, passive devices, buses, memory, storage device and other components are not shown in the figures.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In some implementations, operations or processing may involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining,” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. An electronic system comprising:
a circuit board including a power plane;
an electronic device attached to a first side of the circuit board and arranged to receive power from the power plane; and
a plurality of DC-to-DC converters attached to a second side of the circuit board and arranged to transfer power to the power plane, wherein each DC-to-DC converter of the plurality of DC-to-DC converters includes a respective voltage sense input that is electrically connected to a separate location on the power plane.

2. The electronic system of claim 1, wherein each DC-to-DC converter of the plurality of DC-to-DC converters is positioned within a length and a width of the power plane.

3. The electronic system of claim 2, wherein the respective voltage sense input of each respective DC-to-DC converter is adjacent a position of each respective DC-to-DC converter on the power plane.

4. The electronic system of claim 1, further comprising a supervisor control circuit arranged to detect a voltage of the power plane and to transmit a related control signal to each of the plurality of DC-to-DC converters.

5. The electronic system of claim 4, wherein the detected voltage is an average voltage of the power plane.

6. The electronic system of claim 4, wherein the detected voltage is an average of the voltage sense inputs of each respective DC-to-DC converter.

7. The electronic system of claim 1, wherein each of the plurality of DC-to-DC converters includes a localized control circuit that transfers power to the power plane in response the respective voltage sense input of each DC-to-DC converter.

8. The electronic system of claim 7, wherein each of the plurality of DC-to-DC converters receives an input from a supervisor control circuit and transfers power to the power plane in response to the input.

9. The electronic system of claim 1, further comprising a telemetry circuit coupled to each of the plurality of DC-to-DC converters and arranged to determine a quantity of power transferred to the power plane from each of the plurality of DC-to-DC converters.

10. An electronic system comprising:
a circuit board including a power plane;
an electronic device attached to a first side of the circuit board and arranged to receive power from the power plane; and
a first DC-to-DC converter attached to a second side of the circuit board and arranged to transfer power to the power plane, the first DC-to-DC converter positioned at a first location within a length and a width of the power plane, wherein the first DC-to-DC converter includes a first voltage sense input that senses a voltage of the power plane at the first location; and
a second DC-to-DC converter attached to the second side of the circuit board and arranged to transfer power to the power plane, the second DC-to-DC converter positioned at a second location within the length and the width of the power plane, wherein the second DC-to-DC converter includes a second voltage sense input that senses a voltage of the power plane at the second location.

11. The electronic system of claim 10, wherein the first DC-to-DC converter is arranged to transfer power to the power plane at the first location and wherein the second DC-to-DC converter is arranged to transfer power to the power plane at the second location.

12. The electronic system of claim 10, further comprising a supervisor control circuit arranged to detect a voltage of the power plane and to transmit a related control signal to each of the first and the second DC-to-DC converters.

13. The electronic system of claim 12, wherein the detected voltage is an average voltage of the power plane.

14. The electronic system of claim 12, wherein the detected voltage is an average of the first and the second voltage sense inputs.

15. The electronic system of claim 10, wherein the first DC-to-DC converter includes a first localized control circuit that transfers power to the power plane in response to the first voltage sense input, and wherein the second DC-to-DC converter includes a second localized control circuit that transfers power to the power plane in response to the second voltage sense input.

16. The electronic system of claim 10, wherein the first DC-to-DC converter receives an input signal from a supervisor control circuit and transfers power to the power plane in response to the input signal and wherein the second DC-to-DC converter receives the input signal from the supervisor control circuit and transfers power to the power plane in response to the input signal.

17. The electronic system of claim 10, further comprising a telemetry circuit coupled to the first DC-to-DC converter and arranged to determine a quantity of power transferred to the power plane from the first DC-to-DC converter, the telemetry circuit coupled to the second DC-to-DC converter and arranged to determine a quantity of power transferred to the power plane from the second DC-to-DC converter.

18. An electronic system comprising:
a plurality of power conversion devices arranged to be coupled to a common power plane wherein each power conversion device senses a respective voltage at a different physical location on the common power plane; and
a telemetry circuit arranged to be coupled to each of the plurality of power conversion devices and configured to detect a quantity of power transferred to the common power plane from each of the plurality of power conversion devices.

19. The electronic system of claim 18, wherein each of the plurality of power conversion devices are DC-to-DC converters.

20. The electronic system of claim 18, further comprising a control circuit that is arranged to receive data from the telemetry circuit and in response to receiving the data, transmit control signals to each of the plurality of power conversion devices.
